(19) United States
(12) Patent Application Publication
(10) Pub. No.: US 2008/0267592 A1
(43) Pub. Date: Oct. 30, 2008

(54) Jewelry display box with digital output apparatus

(76) Inventors: Keith Kevin Fiala, Wimberley, TX (US); Anna Marie Romano, Austin, TX (US)

Correspondence Address: DAVID ODELL SIMMONS, 7637 PARKVIEW CIRCLE, AUSTIN, TX, 78731, US

(21) Appl. No.: 11/789,948

(22) Filed: Apr. 26, 2007

(51) Int. Cl. H04N 7/26; A45C 11/00; H04R 1/02

(52) U.S. Cl. 386/124; 381/87; 206/6.1

(57) ABSTRACT

A jewelry presentation apparatus comprises an enclosure, a jewelry retention structure and a digital content presentation system. The enclosure includes a cover that is moveably attached to a main body in a manner whereby the main body and the cover jointly define enclosable interior space of the enclosure. The cover is movable with respect to the main body for allowing access to the interior space. The jewelry retention structure is mounted on the enclosure within the interior space and is configured for retaining a jewelry item in an intended position. The digital content presentation system is mounted on the enclosure. The digital content presentation system is configured for storing digital content information and for audibly outputting an audio component of the digital content information via an audio output device thereof. Audibly outputting the audio component commences in response to the cover being moved to allow access to the interior space.

### FIELD OF THE DISCLOSURE

The disclosures made herein relate generally to jewelry display boxes and, more particularly, to a jewelry display box with means for outputting audio and/or video content.

### BACKGROUND

Jewelry is often given to recognize a special moment or a significant event. Examples of such a special moment or a significant event include, but are not limited to, a wedding engagement, a birthday, a holiday, an anniversary, or simply an expression of affection. Regardless of the reason for the giving of jewelry, the lasting representation of the special moment or significant event that the jewelry provides makes the moment of giving a special and remembered occasion for both the giver and the recipient.

In many instances, the special moment or significant event corresponding to the giving of jewelry has associated audible and/or visual content having special significance with respect to such moment or event. In one example, a bride and groom will share a special song. In another example, pictures and/or video content that captures past moments together will chronicle a couple's anniversary. In still another example, a holiday will be most notably remembered by a person through a particular song or video.

Accordingly, an article and a method that each facilitate combining the giving of jewelry with playing of audio and/or visual content that has special meaning behind or complimentary meaning to the giving of such jewelry is advantageous, desirable and useful.

### SUMMARY OF THE DISCLOSURE

Embodiments of the present invention facilitate combining the giving of jewelry with playing of audio and/or visual content that has special meaning behind or complimentary meaning to the giving of such jewelry. More specifically, embodiments of the present invention are configured such that audio and/or video content is outputted from a content presentation system (e.g., a digital content presentation system) that is integral with an enclosure in which such jewelry is contained. In doing so, embodiments of the present invention advantageously enhance the giving of jewelry for occasions such as, for example, a wedding engagement, a birthday, a holiday, an anniversary, or simply an expression of affection.

In one embodiment of the present invention, a jewelry presentation apparatus comprises an enclosure, a jewelry retention structure and a content presentation system. The enclosure includes a main body and a cover. The cover is moveably attached to the main body in a manner whereby the main body and the cover jointly define enclosable interior space of the enclosure. The cover is movable with respect to the main body for allowing access to the interior space. The jewelry retention structure is mounted on the enclosure within the interior space and is configured for retaining a jewelry item in an intended position. The content presentation system, which is preferably but not necessarily a digital content presentation system, is mounted on the enclosure. The content presentation system is configured for storing content information (e.g., a digital content file) and for audibly outputting an audio component of the content information via an audio output device thereof. Audibly outputting the audio component of the content information commences in response to the cover being moved to allow access to the interior space.

In another embodiment of the present invention, a jewelry presentation apparatus comprises an enclosure, a jewelry retention structure and a digital content presentation system. The enclosure includes a main body and a cover. The cover is moveably attached to the main body in a manner whereby the main body and the cover jointly define enclosable interior space of the enclosure. The cover is movable with respect to the main body for allowing access to the interior space. The jewelry retention structure is mounted on the enclosure within the interior space and is configured for retaining a jewelry item in an intended position. The digital content presentation system is mounted on the enclosure within the interior space. The digital content presentation system includes a processor, memory couple to the processor, an audio output device coupled to the processor, an output activation device coupled to the processor, and instructions accessible from the memory by the processor and processable by the processor. The instructions are configured for enabling the processor to facilitate receiving an output activation signal from the output activation device in response to the cover being moved for allowing access to the interior space, accessing digital content information from the memory in response to receiving the output activation signal, and beginning audible output of an audio component of the digital content information via the audio output device in response to accessing the digital content information.

In another embodiment of the present invention, a digital content presentation assembly is configured for being mounted on a jewelry presentation enclosure. The digital content presentation assembly includes a mounting structure and a digital content presentation system. The mounting structure is configured for being fixedly mounted within an interior space of a jewelry presentation enclosure. The digital content presentation system is attached to the mounting structure whereby the digital content presentation system and the mounting structure are mountable within and removable from the interior space of the jewelry presentation enclosure as an assembly. The digital content presentation system is configured for storing digital content information and for audibly outputting an audio component of the digital content information via an audio output device thereof. Audibly outputting of the audio component of the digital content information commences in response to a cover of the jewelry presentation enclosure being manipulated for allowing access to the interior space and/or a manual activation device being acted upon.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a front perspective view showing an embodiment of a jewelry presentation apparatus in accordance with the present invention, wherein the jewelry presentation apparatus is shown in an open orientation.

FIG. 2 is a rear perspective view of the jewelry presentation apparatus in FIG. 1, wherein the jewelry presentation apparatus is shown in a closed orientation.

FIG. 3 is a cross-sectional view taken along the line 3-3 in FIG. 2.

FIG. 4 is a schematic view of a digital content presentation system of the jewelry presentation apparatus shown in FIG. 1.

FIG. 5 shows an embodiment of operating instructions for a digital content presentation system in accordance with the present invention.

FIG. 6 is a front perspective view showing a digital content presentation assembly in accordance with the present invention, wherein the digital content presentation assembly is mounted on a jewelry presentation enclosure.

FIG. 7 is a cross-sectional view of the digital content presentation assembly and jewelry presentation enclosure shown in FIG. 6.

### DETAILED DESCRIPTION OF THE DRAWING FIGURES

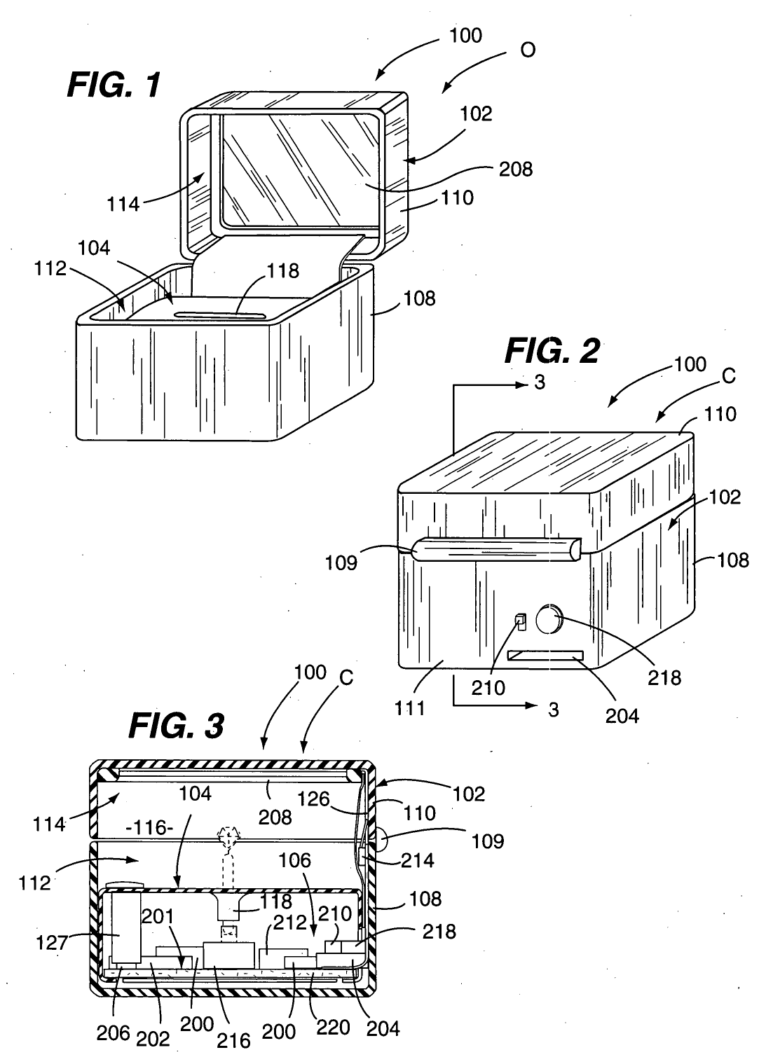

FIGS. 1-3 show various aspects of a jewelry presentation apparatus 100, which is configured in accordance with the present invention. The jewelry presentation apparatus 100 comprises an enclosure 102, a jewelry retention structure 104 and a digital content presentation system 106 (shown in FIG. 3). The enclosure 102, the jewelry retention structure 104 and the digital content presentation system 106 are integrally coupled for allowing a jewelry item to be supported in a fixed orientation within the enclosure 102 and for facilitating outputting of audio and/or video content to be outputted in response to the enclosure being manipulated for allowing access to the jewelry item. In this manner, the jewelry presentation apparatus 100 facilitate combining the giving of jewelry with playing of audio and/or visual content that has special meaning behind or complimentary meaning to the giving of such jewelry.

The enclosure 102 includes a main body 108 and a cover 110. The cover 110 is pivotably attached to the main body 108 via a hinge assembly 109 for allowing the cover 110 to be pivoted between an open position O (FIG. 1) and a closed position C (FIGS. 2 and 3) with respect to the main body 108. The main body 108 includes a cavity 112 therein and the cover 110 includes a cavity 114 therein. The main body 108 and the cover 110 are pivotably connected in a manner whereby the cavity 112 of the main body and the cavity 114 of the main body 108 jointly define an enclosable interior space 116 (FIG. 3) when the cover 110 is in the closed position C. Thus, the cover 110 is pivotable with respect to the main body 108 for allowing access to the interior space 116.

It is disclosed herein that a jewelry presentation apparatus in accordance with the present invention can have a cover that is movably engaged with a main body in a manner besides pivotably. For example, the cover can be slideably engaged with the main body such that access to an interior space of the enclosure is provided for by sliding the cover with respect to the main body. Accordingly, the present invention is not limited to a specific means of engagement between a cover and main body of an enclosure.

The jewelry retention structure 104 is mounted within the cavity 112 of the main body 108 and is configured for retaining a jewelry item in an intended position. An upright position, and/or fixed position are examples of intended positions. The jewelry retention structure 104 includes a jewelry retention feature 118 (FIGS. 1 and 3) configured for supporting a jewelry item in an intended position. As shown, the jewelry retention feature 118 includes a slotted receptacle configured for holding a ring in an upright position. It is disclosed herein that the present invention is not limited to a jewelry retention feature 118 configured for retaining a particular type, size or shape of jewelry. Accordingly, a jewelry retention feature in accordance with the present invention can be configured for holding a ring, a watch, and/or many other types, sizes and shapes of jewelry.

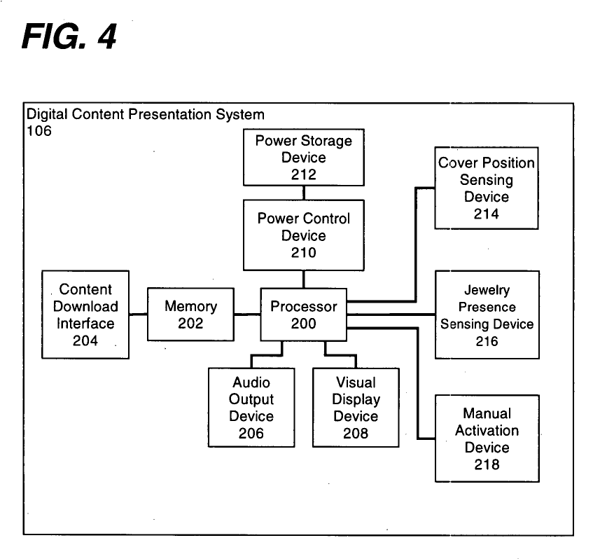

Referring now to FIG. 4, in one embodiment, the digital content presentation system 106 includes a processor 200, memory 202, a content download interface 204, an audio output device 206, a visual display device 208, a power control device 210, a power storage device 212, a cover position sensing device 214, a jewelry presence sensing device 216 and a manual activation device 218. The processor 200, the memory 202, the content download interface 204, the audio output device 206, the visual display device 208, the power control switch 210, the power storage device 212, the cover position sensing device 214, the jewelry presence sensing device 216 and the manual activation device 218 are interconnected for allowing digital content information to be audibly and/or visually outputted in accordance with the present invention.

The processor 200 is configured for facilitating output of digital content information. The processor accesses instructions stored on the memory 202 all or a portion of the memory can be integral with the processor 200. These instructions are configured for allowing audio and/or visual content (i.e., digital content information) to be outputted in accordance with the present invention. The memory 202 (e.g., non-volatile flash memory) is coupled between the processor 200 and the content download interface 204. The processor 200 accesses digital content information (i.e., a digital content file) from the memory 202. The content download interface (e.g., a USB connector) is coupled to the memory 202 for allowing such digital content information to be downloaded to the memory 202 from an external source. The audio output device 206 (e.g., a speaker) and the visual display device 208 (e.g., a LCD panel) are coupled to the processor 200 for allowing audio and video components, respectively, of the digital content information to be outputted. The power control device 210 is coupled between the processor 200 and the power storage device 212. The power control device 210 (e.g., a switch) allows electrical power to be selectively supplied from the power storage device 212 to the processor 200. The cover position sensing device 214 (e.g., a switch) senses a position and/or movement of the cover 110 (FIGS. 1-3), thereby allowing the processor 200 to facilitate digital content presentation dependent on a position and/or movement of the cover 110. The jewelry presence sensing device 216(e.g., a switch) senses presence of a jewelry item when such jewelry item is retained by the jewelry retention structure 104 (e.g., via the jewelry depressing a sensing member of the switch), thereby allowing the processor 200 to facilitate digital content presentation dependent on presence of the jewelry item. The manual activation device 218 (e.g., a switch) is configured for being manually acted on by a user, thereby allowing the processor 200 to facilitate digital content presentation dependent on manual activation by a user.

Referring now to FIGS. 1-3, the digital content presentation system 106 is mounted on the enclosure 102. More specifically, a processor module of the digital content presentation system 106 (represented generally as processor module 201) is mounted within the cavity 112 of the main body 108 and the visual display device 208 of the digital content presentation system 106 is mounted within the cavity 114 of the cover 110. The processor module 201 of the digital content presentation system 106 and the visual display device 208 can be secured in place by means such as, for example, adhesive, friction, mechanical fastener, or the like. As shown, in one embodiment, the processor module 201 includes the processor 200, the memory 202, the content download interface 204, the audio output device 206, the power control device 210, the power storage device 212, the jewelry presence sensing device 216 and the manual activation device 218 are mounted on a circuit substrate 220. The visual display device 208 is configured and orientated such that it is viewable when the cover is in the open position O with respect to the main body 108. A cover position sensing device 214 is engaged between main body 108 and the cover 110 for sensing a position of the cover 110 with respect to the main body 108. A conductor implement 126 such as, for example, a flat ribbon cable, flexible circuit, etc, is connected between the circuit substrate assembly 220, the visual display device 208 and the cover position sensing device 214 for allowing electrical interaction therebetween. Through electrical interaction with the circuit substrate 220, the visual display device 208 and the cover position sensing device 214 can interact with the components residing on the circuit substrate 220. For accessibility, the content download interface 204, the power control device 210 and the manual activation device 218 can be made accessible through a wall 111 of the main body 108. To enhance sound clarity and volume, a sound conduit 127 (e.g., a tubular body) can extend from adjacent the audio output device 206 through an aperture in the jewelry retention structure 104. Optionally, the audio output device 206 can be mounted so as to be unobstructed by the jewelry retention structure 104.

The digital content presentation system 106 is configured for storing digital content information and outputting all or a portion of such digital content information. In one embodiment, such outputting of the digital content information is performed in response to the cover position sensing device 214 sensing that the cover 110 is in transition to or is in the open position O, and in response to the jewelry presence sensing device 216 sensing that a jewelry item is engaged with the jewelry retention structure 104.

In one embodiment of the present invention, the processor 200, the memory 202, the content download interface 204, the audio output device 206, the visual display device 208, the power control device 210 and the power storage device 212 are configured for providing audio and/or video content output of MP3 digital media files. To this end, the digital content presentation system 106 is configured to receive and store downloaded digital media files, to access and interpret such files and to audibly and/or visually output such files in a manner equivalent to that of an Apple™ iPod™. The present invention is not limited to any particular hardware configuration, but rather to any hardware configuration that provides for outputting of digital content information such as, for example, an MP3 file.

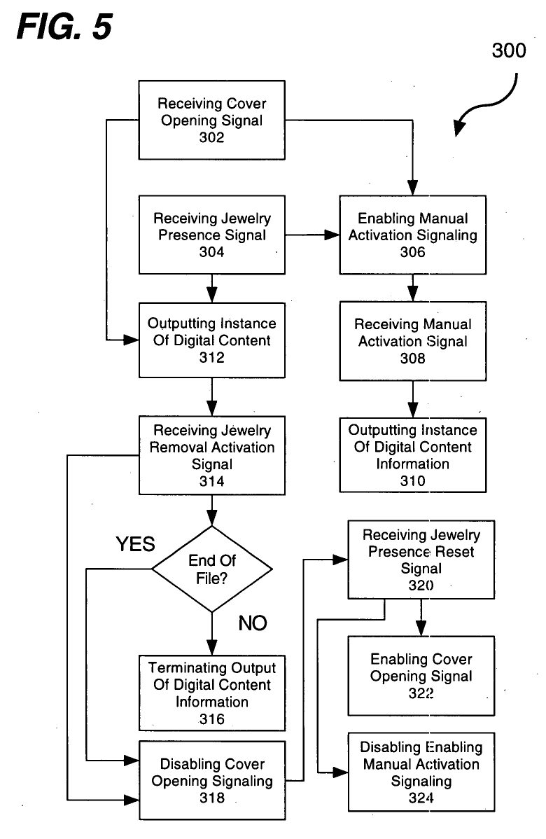

FIG. 5 shows an embodiment of operating instructions 300 for the digital content presentation system 106 of the jewelry presentation apparatus 100 discussed above. The operating instructions 300 perform an operation 302 for receiving a cover opening signal and an operation 304 for receiving a jewelry presence signal. The jewelry opening signal indicates that the cover 110 of the enclosure 102 is in an open position or is moving to the open position and the jewelry presence signal indicates that a jewelry item is in an intended position with respect to the digital content presentation system 106 (i.e., retained by the jewelry retention structure). After receiving the jewelry opening signal and the jewelry presence signal, an operation 306 is performed for enabling the manual activation signalling (e.g., activation via acting on a manual switch). In response to enabling the manual activation signalling, an operation 308 being performed for receiving a manual activation signal causes an operation 310 to be performed for outputting an instance of digital content information (e.g., user initiated replay functionality). Also after receiving the jewelry opening signal and the jewelry presence signal, an operation 312 is performed for outputting an instance of digital content information. Such outputting includes accessing and interpreting such digital content information. At some point after outputting of the digital content information is initiated, an operation 314 is performed for receiving a jewelry removal signal indicating that the jewelry item has been removed from the intended position with respect to the digital content presentation system 106. In response to receiving the jewelry removal signal, an operation 316 is performed for terminating output of the digital content information if the instance of the digital content information has not already been completely outputted. Otherwise, or after terminating output of the digital content information, an operation 318 is performed for disabling the cover opening signal so that subsequent instances of opening the cover 110 do not result in repeated outputting of the digital content information so long as a suitable jewelry item is not sensed in its intended position with respect to the digital content presentation system 106. At some point in time after disabling the cover opening signal, an operation 320 is performed for receiving a jewelry presence reset signal that indicates that a jewelry item is in its intended position with respect to the digital content presentation system 106. In response to receiving the jewelry presence reset signal, an operation 322 is performed for enabling the cover opening signal and an operation 324 is performed for disabling manual activation signalling. Enabling the cover opening signal causes an instance of the digital content information to be outputted when opening the cover 110 when a jewelry item is in its intended position with respect to the digital content presentation system 106. Disabling the manual activation signalling inhibits an instance of the digital content information from being outputted in response to the manual activation device being manually acted on (e.g., manually depressed)

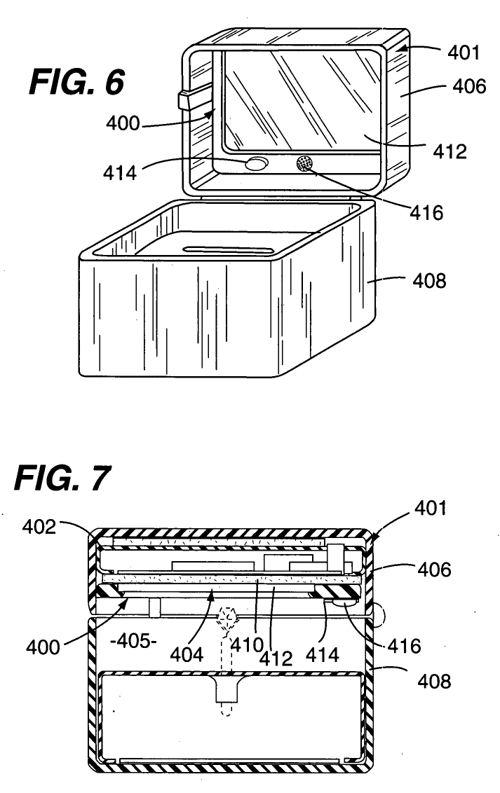

FIGS. 6 and 7 show an embodiment of a digital content presentation assembly 400 configured for being mounted on a jewelry presentation enclosure 401. Preferably, but not necessarily, the jewelry presentation enclosure 401 is a conventional jewelry presentation enclosure such that the digital content presentation assembly 400 is retrofitable in such a conventional jewelry presentation enclosure. The digital content presentation assembly 400 includes a mounting structure 402 and a digital content presentation system 404. The mounting structure 402 is configured for being engaged within an interior space 405 of the jewelry presentation enclosure 401, which is at least partially defines by a cavity in the cover 406 and/or a cavity in the main body 408. The digital content presentation system 404 is attached to the mounting structure 402 in a manner whereby the digital content presentation system 404 and the mounting structure 402 are mountable within and removable from the interior space of the jewelry presentation enclosure 401 as an assembly. Preferably, but not necessarily, the mounting structure 402 is configured for being mounted entirely within a cavity of a cover 406 of the jewelry presentation enclosure 401 (as shown in FIGS. 6 and 7) or entirely within a cavity of a main body 408 of the jewelry presentation enclosure 401. The mounting structure 402 can be secured in place by means such as, for example, adhesive, friction, mechanical fastener, or the like.

The digital content presentation system 404 is substantially structurally and the same as the digital content presentation system 106 of FIGS. 1-4 with the following exceptions. The digital content presentation system 404 includes a circuit substrate 410 having a visual display 412, a manual activation device 414 and an audio output device 416 attached to a first side of the circuit substrate 410. The remaining major components of the digital content presentation system 404 are attached to a second side of the circuit substrate 410. The mounting structure 402 is attached to the digital content presentation system 404 such that the visual display 412, the manual activation device 414 and the audio output device 416 are accessible/visible when the cover 406 is in an open position. The digital content presentation system 404 is configured for storing digital content information and for outputting the digital content information via the audio output device 416 and/or visual display device 412. The digital content presentation system 404 is configured for outputting the digital content information in response to the manual activation device 414 being acted upon and/or, optionally, the cover 406 of the jewelry presentation enclosure 401 being manipulated for allowing access to the interior space thereof. For example, the digital content presentation system 404 can include a cover position sensing device (e.g., reed switch, membrane switch, optical switch or the like) configured for sensing position of the cover 406 of the jewelry presentation enclosure 401 with respect to a main body 408 of the jewelry presentation enclosure 401,thereby allowing such outputting in response to the cover 406 of the jewelry presentation enclosure 401 being manipulated for allowing access to the interior space thereof. In such an embodiment, the cover position sensing device causes the outputting of the digital content information to commence in response to the cover 406 being moved to from a closed position toward an open position. Optionally, a manual activation device is acted on for causing outputting of the digital content information to commence

It is disclosed wherein that a digital content presentation system 404 in accordance with the present invention can be configured for outputting an audio component of digital content information and/or a visual component of the digital content information. As shown in the digital content presentation system of FIGS. 1-4 and the digital content presentation system of FIGS. 6-7, such digital content presentation systems are each configured for outputting an audio component and visual component of a digital content information. Alternatively, a digital content presentation system in accordance with the present invention can be configured solely outputting audio digital content information (e.g., music, a voice message, etc). In embodiments where a digital content presentation system in accordance with the present invention is configured solely for outputting audio digital content information, system components necessitated solely by visual output functionality (e.g., the visual display device) can be omitted.

In the preceding detailed description, reference has been made to the accompanying drawings that form a part hereof, and in which are shown by way of illustration specific embodiments in which the present invention can be practiced. These embodiments, and certain variants thereof, have been described in sufficient detail to enable those skilled in the art to practice embodiments of the present invention. It is to be understood that other suitable embodiments can be utilized and that logical, mechanical, chemical and electrical changes can be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A jewelry presentation apparatus, comprising:
an enclosure including a main body and a cover, wherein the cover is moveably attached to the main body in a manner whereby the main body and the cover jointly define enclosable interior space of the enclosure and wherein the cover is movable with respect to the main body for allowing access to said interior space;
a jewelry retention structure mounted on the enclosure within the interior space and configured for retaining a jewelry item in an intended position; and
a digital content presentation system mounted on the enclosure, wherein the digital content presentation system is configured for storing digital content information and for audibly outputting an audio component of said digital content information via an audio output device thereof and wherein said audibly outputting commences in response to the cover being moved to allow access to said interior space.

2. The jewelry presentation apparatus of claim 1 wherein:
the digital content presentation system is mounted on the enclosure within said interior space.

3. The jewelry presentation apparatus of claim 2 wherein
the digital content presentation system includes a download interface, an activation device and a power control switch; and
the download interface, the activation device and the power control switch are accessible through a wall of the enclosure.

4. The jewelry presentation apparatus of claim 3 wherein:
the digital content presentation system is configured for visually outputting a video component of said digital content information via a visual display device thereof; and
said visually outputting is performed in combination with said audibly outputting.

5. The jewelry presentation apparatus of claim 1 wherein:
the digital content presentation system is configured for visually outputting a video component of said digital content information via a visual display device thereof; and
said visually outputting is performed in combination with said audibly outputting.

6. The jewelry presentation apparatus of claim 1 wherein:
the digital content presentation system includes a cover position sensing device configured for sensing position of the cover with respect to the main body; and
the cover position sensing device causes said audibly outputting of the audio component of said digital content information to commence in response to the cover being moved from a closed position toward an open position.

7. The jewelry presentation apparatus of claim 6 wherein:
the digital content presentation system includes a jewelry presence sensing device configured for sensing presence of the jewelry item when the jewelry item is retained by the jewelry retention structure;
the jewelry presence sensing device enables the cover position sensing device to cause said audibly outputting of the audible component: of said digital content information to commence in response to the jewelry presence sensing device sensing that the jewelry item is retained by the jewelry retention structure; and
the jewelry presence sensing device inhibits the cover position sensing device from cause said audibly outputting of the audible component of said digital content information to commence in response to the jewelry presence sensing device sensing that the jewelry item is not retained by the jewelry retention structure.

8. The jewelry presentation apparatus of claim 7 wherein the jewelry retention structure includes an opening therein for receiving a band of a ring for retaining the ring in an intended position.

9. The jewelry presentation apparatus of claim 8 wherein:
the digital content presentation-system is configured for visually outputting a video component of said digital content information via a visual display device thereof; and
said visually outputting is performed in combination with said audibly outputting.

10. The jewelry presentation apparatus of claim 9 wherein the digital content presentation system is mounted on the enclosure within said interior space.

11. The jewelry presentation apparatus of claim 10 wherein the visual display device is mounted on the cover within said interior space.

12. A jewelry presentation apparatus, comprising:
an enclosure including a main body and a cover, wherein the cover is moveably attached to the main body in a manner whereby the main body and the cover jointly define enclosable interior space of the enclosure and wherein the cover is movable with respect to the main body for allowing access to said interior space;
a jewelry retention structure mounted on the enclosure within the interior space and configured for retaining a jewelry item in an intended position; and
a digital content presentation system mounted on the enclosure within the interior space and including:
at least one processor;
memory couple to said at least one processor;
an audio output device coupled to said at least one processor;
an output activation device coupled to said at least one processor; and
instructions accessible from said memory by said at: least one processor and processable by said at least one processor;
wherein said instructions are configured for enabling said at least one processor to facilitate:
receiving an output activation signal from the output activation device in response to the cover being moved for allowing access to the interior space;
accessing digital content information from said memory in response to receiving the output activation signal; and
beginning audible output of an audio component of said digital content information via the audio output device in response to accessing said digital content information.

13. The jewelry presentation apparatus of claim 12 wherein the digital content presentation system is mounted on the enclosure within said interior space.

14. The jewelry presentation apparatus of claim 13 wherein
the digital content presentation system includes a download interface, a manual activation device and a power control switch; and
the download interface, the manual activation device and the power control switch are accessible through a wall of the enclosure.

15. The jewelry presentation apparatus of claim 14 wherein:
the digital content presentation system includes a visual display device coupled to said at least one processor;
the visual display-device is mounted on the cover within said interior space;
said instructions are configured for enabling said at least one processor to facilitate visually outputting a video component of said digital content information via the visual display device; and
said visually outputting is performed in combination with said audibly outputting.

16. The jewelry presentation apparatus of claim 15 wherein:
the digital content presentation system includes a cover position sensing device configured for sensing position of the cover with respect to the main body; and
the cover position sensing device causes said outputting of said digital content information to commence in response to the cover being moved to from a closed position toward an open position.

17. The jewelry presentation apparatus of claim 16 wherein:
the digital content presentation system includes a jewelry presence sensing device configured for sensing presence of the jewelry item when the jewelry item is retained by the jewelry retention structure;
the jewelry presence sensing device enables the cover position sensing device to cause said outputting of said digital content information to commence in response to the jewelry presence sensing device sensing that the jewelry item is retained by the jewelry retention structure; and
the jewelry presence sensing device inhibits the cover position sensing device from cause said outputting of said digital content information to commence in response to the jewelry presence sensing device sensing that the jewelry item is not retained by the jewelry retention structure.

18. A digital content presentation assembly configured for being mounted on a jewelry presentation enclosure, comprising:
a mounting structure configured for being fixedly mounted within an interior space of a jewelry presentation enclosure; and
a digital content presentation system attached to the mounting structure whereby the digital content presentation system and the mounting structure is mountable within and removable from the interior space of the jewelry presentation enclosure as an assembly, wherein the digital content presentation system is configured for storing digital content information and for audibly outputting an audio component of said digital content information via an audio output device thereof and wherein said audibly outputting commences in response to at least one of a cover of the jewelry presentation enclosure being manipulated for allowing access to the interior space and a manual activation device being acted upon.

19. The digital content presentation assembly of claim 18 wherein:
the digital content presentation system includes a cover position sensing device configured for sensing position of the cover of the jewelry presentation enclosure with respect to a main body of the jewelry presentation enclosure; and
the cover position sensing device causes said audibly outputting of the audio component of said digital content information to commence in response to the cover being moved to from a closed position toward an open position.

20. The digital content presentation assembly of claim 19 wherein:
the digital content presentation system is configured for visually outputting a video component of said digital content information via a visual display device thereof; and
said visually outputting commences in combination with said visually outputting.
